(19) United States
(12) Patent Application Publication
(10) Pub. No.: US 2024/0206026 A1
(43) Pub. Date: Jun. 20, 2024

(54) ELECTRONIC COMPONENT

(71) Applicant: DIAMOND&ZEBRA ELECTRIC MFG. CO., LTD., Osaka (JP)

(72) Inventor: Takashi IKEBE, Osaka (JP)

(73) Assignee: DIAMOND&ZEBRA ELECTRIC MFG. CO., LTD., Osaka (JP)

(21) Appl. No.: 18/515,562

(22) Filed: Nov. 21, 2023

(30) Foreign Application Priority Data
Dec. 20, 2022 (JP) 2022-203269

(51) Int. Cl. H05B 6/42; H01F 27/02

(52) U.S. Cl. CPC H05B 6/42; H01F 27/022

(57) ABSTRACT

An electronic component 2 includes: an annular heat-generating element 24; an electrically insulating case 6 including a bottom 22 and a side wall 20 and containing the heat-generating element 24; a pillar 8 extending upward from the bottom 22 and passing through the heat-generating element 24; and a thermally conductive filler 9 located within the case 6. The pillar 8 includes an electrically insulating tube 27 and a bar 28 located inside the tube 27 and having a higher thermal conductivity than the filler 9. Preferably, the filler 9 is located between the tube 27 and the bar 28.

### CROSS-REFERENCE TO RELATED APPLICATION

This application claims priority on and the benefit of Patent Application No. 2022-203269 filed in JAPAN on Dec. 20, 2022. The entire disclosures of this Japanese Patent Application are hereby incorporated by reference.

### BACKGROUND OF THE INVENTION

### Field of the Invention

The present specification discloses an electronic component.

### Description of the Related Art

An electronic device that includes a coil such as a toroidal coil or transformer may generate a large amount of heat when in use. Such a heat-generating electronic component often has a structure where a case made of a resin composition or metal contains therein a “heat-generating element” that actually generates heat and where a resin excellent in thermal conductivity is located as a filler within the case. An example of the heat-generating electronic component is reported in Japanese Laid-Open Patent Application Publication No. 2011-210791.

When the heat-generating element is an annular one such as a coil which has a large central hole, the amount of the resin used as a filler is large. Resins excellent in thermal conductivity are expensive. Thus, there is a demand to minimize the amount of the resin used as a filler in order to achieve cost reduction. In particular, when the electronic component is one in which the case is made of a resin composition, it is important to reduce the amount of the resin used as a filler and at the same time ensure high heat dissipation performance.

The present inventors aim to provide an electronic component that is low in cost and has high heat dissipation performance.

### SUMMARY OF THE INVENTION

An electronic component includes: an annular heat-generating element; an electrically insulating case including a bottom and a side wall and containing the heat-generating element; a pillar extending upward from the bottom and passing through the heat-generating element; and a thermally conductive filler located within the case. The pillar includes an electrically insulating tube and a bar located inside the tube and having a higher thermal conductivity than the filler.

The electronic component includes the pillar passing through the annular heat-generating element. Since the pillar fills a part of the central hole of the heat-generating element, the amount of the filler can be reduced. Furthermore, the pillar includes the bar located in its interior and having a higher thermal conductivity than the filler. The bar contributes to high heat dissipation performance of the electronic component. The electronic component is low in cost and has high heat dissipation performance.

### BRIEF DESCRIPTION OF THE DRAWINGS

FIG. 1 is a perspective view showing an electronic component according to one embodiment.

FIG. 2 is an exploded perspective view of the electronic component of FIG. 1.

FIG. 3 is a cross-sectional view of the electronic component of FIG. 1 taken along the line III-III.

FIG. 4 is a perspective view showing a case and a pillar of the electronic component of FIG. 1.

FIG. 5 is an enlarged cross-sectional view showing a part of FIG. 3.

FIG. 6 is a cross-sectional view showing the electronic component of FIG. 1 as fixed to an electronic device.

FIG. 7 is a cross-sectional view showing a case and a pillar of an electronic component according to another embodiment.

FIG. 8 is a cross-sectional view showing a case and a pillar of an electronic component according to yet another embodiment.

### DESCRIPTION OF THE PREFERRED EMBODIMENTS

The following will describe in detail preferred embodiments with appropriate reference to the drawings.

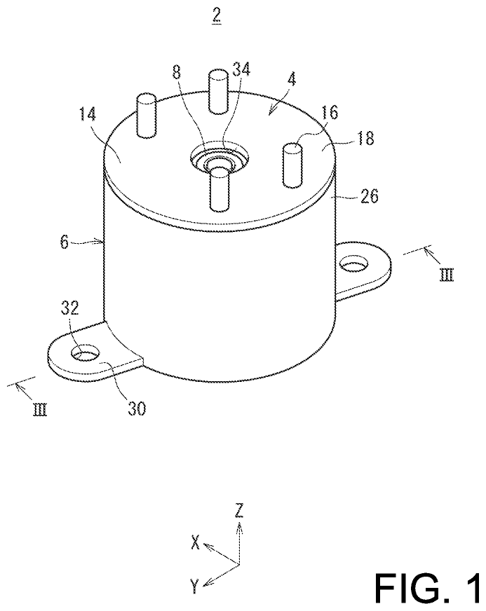

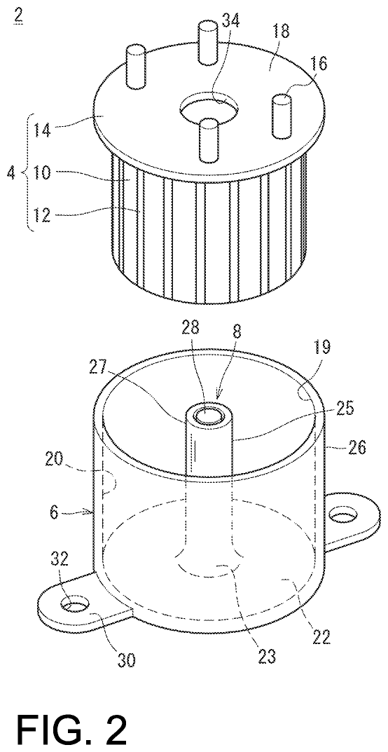

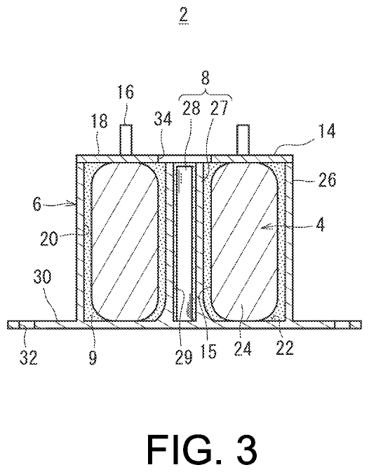

FIG. 1 is a perspective view showing an electronic component 2 according to one embodiment. In FIG. 1, the arrow X represents the forward direction with respect to the electronic component 2. The opposite direction is the backward direction. The arrow Y represents the rightward direction with respect to the electronic component 2. The opposite direction is the leftward direction. The arrow Z represents the upward direction with respect to the electronic component 2. The opposite direction is the downward direction. FIG. 2 is an exploded perspective view of the electronic component 2 of FIG. 1. FIG. 3 is a cross-sectional view taken along the line III-III of FIG. 1. As shown in FIGS. 1 to 3, the electronic component 2 includes a toroidal coil 4, a case 6, and a pillar 8. As shown in FIG. 3, the electronic component 2 further includes a filler 9 located within the case 6. In FIG. 2, the filler 9 is omitted.

As shown in FIG. 2, the toroidal coil 4 includes a core 10, a wire 12, and a top plate 14. The core 10 is annular although the core 10 is not seen in its entirety in FIG. 2. That is, as shown in FIG. 3, the core 10 includes a central hole 15 extending through the core 10 in the up-down direction (the axial direction of the core 10). The core 10 is made of a magnetic material whose surface is covered with a resin composition. Preferred examples of the magnetic material include ferrite, dust, and silicon steel. The wire 12 is helically wound around the outer circumference of the core 10. The wire 12 is typically made of copper. In FIG. 3, the core 10 and the wire 12 are depicted in a simplified manner. In FIG. 3, the core 10 and the wire 12 are collectively depicted as one cross-section.

As shown in FIG. 1, the top plate 14 is located outside the case 6. In this embodiment, the entire top plate 14 is located outside the case 6. A part of the top plate 14 may be located inside the case 6. As shown in FIG. 2, the top plate 14 is placed on the upper surface of the core 10. The top plate 14 includes a lid 18 and a terminal 16. In this embodiment, the lid 18 is circular in plan view. The lid 18 covers an opening of the case 6 described later. At the center of the lid 18 there is a hole 34.

The terminal 16 is located on the upper surface of the lid 18. There are a plurality of terminals 16 on the upper surface of the lid 18. The terminals 16 are electrically connected to the wire 12. Electricity is externally applied to the wire 12 through the terminals 16. Upon application of electricity to the wire 12 wound around the core 10, the toroidal coil 4 generates heat. The toroidal coil 4 is a heat generator. The portion of the heat generator that actually generates heat is referred to as a heat-generating element. In this embodiment, the core 10 and the wire 12 constitute a heat-generating element 24. The heat-generating element 24 is annular and includes the central hole 15.

As shown in FIG. 2, the case 6 includes a side wall 20 and a bottom 22. The case 6 includes an internal space. The heat-generating element 24 is contained within the space. In this embodiment, the case 6 is in the shape of a cylindrical tube as shown in FIG. 2. The case 6 includes an opening 19 at its upper surface. The case 6 is electrically insulating. In this embodiment, the case 6 is made of a resin composition. Preferred examples of the material of the case 6 include PBT (polybutylene terephthalate), PPS (polyphenylene sulfide), and PET (polyethylene terephthalate). In the present specification, the statement that a material is “electrically insulating” means that the electrical conductivity of the material is 10-6 S/m or less. “S” denotes siemens which is the reciprocal of resistance “Q (ohm)”, and “m” denotes distance (meter).

The case 6 includes a body 26 and a protrusion 30. The body 26 is tubular. The protrusion 30 is located at the lower end of the body 26. The protrusion 30 projects outward from the body 26 in the radial direction of the case 6. In this embodiment, there are two such protrusions 30. There may be three or more protrusions 30. Each of the protrusions 30 includes an attachment hole 32. The body 26 and the protrusions 30 are integrally formed. The body 26 and the protrusions 30 may be separately formed.

The pillar 8 is located on the bottom 22 of the case 6. The pillar 8 extends upward from the bottom 22 of the case 6. In this embodiment, the pillar 8 includes a lower portion 23 and an upper portion 25. The lower portion 23 extends from the bottom 22 of the case 6 and has a diameter that gradually decreases upward. The lower portion 23 is in the shape of a frustum. In the cross-section of FIG. 3, the side surface of the lower portion 23 is curved. The upper portion 25 extends upward from the lower portion 23 and has a substantially constant diameter. In this embodiment, the lower portion 23 is in the shape of a truncated cone and the upper portion 25 is in the shape of a cylindrical tube. That is, the pillar 8 is circular in a cross-section perpendicular to the up-down direction. In this embodiment, the pillar 8 extends to the level of the upper end of the case 6 in the up-down direction.

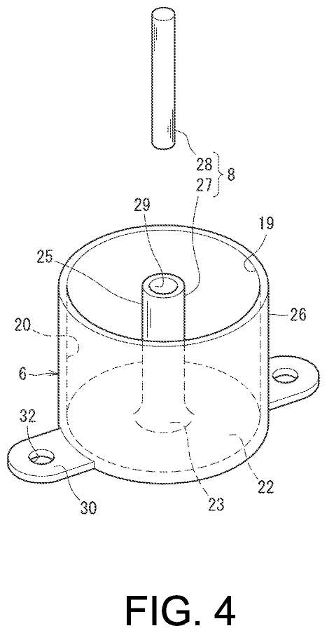

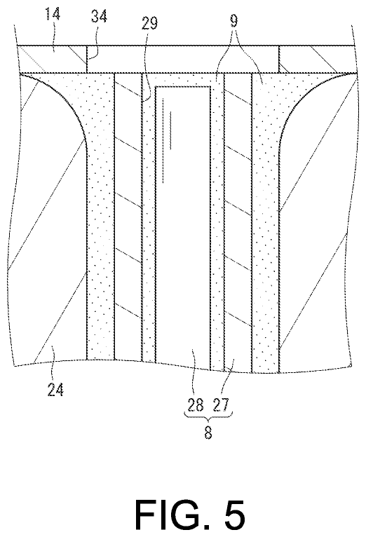

As shown in FIGS. 2 and 3, the pillar 8 includes a tube 27 and a bar 28. FIG. 4 is a perspective view showing the bar 28, the pillar 8 from which the bar 28 has been removed, and the case 6. FIG. 5 shows a part of FIG. 3 in an enlarged view.

The tube 27 includes an internal space 29. In this embodiment, the internal space 29 extends from the upper surface of the tube 27 to the bottom 22 of the case 6. The tube 27 is open at its upper surface. The tube 27 is electrically insulating. In this embodiment, the tube 27 is made of a resin composition. Preferred examples of the material of the tube 27 include PBT, PPS, and PET. In this embodiment, the tube 27 is formed integrally with the case 6. The tube 27 and the case 6 may be separately formed.

The bar 28 is located in the internal space 29 of the tube 27. In this embodiment, there is a gap between the bar 28 and the tube 27. The outer diameter of the bar 28 is smaller than the diameter of the internal space 29 of the tube 27. In this embodiment, as shown in FIG. 3, the bar 28 located in the internal space 29 is in contact with the bottom 22 of the case 6. The bar 28 has a high thermal conductivity. The thermal conductivity of the bar 28 is higher than the thermal conductivity of the filler 9. Specifically, the thermal conductivity of the bar 28 is 10 W/m·K or more. “W” denotes electrical power (watt), “m” denotes distance (meter), and “K” denotes temperature (kelvin). In this embodiment, the bar 28 is made of a metal. Preferred examples of the material of the bar 28 include aluminum alloys.

The filler 9 fills gaps within the case 6. The filler 9 fills the gap between the heat-generating element 24 and the case 6 and the gap between the heat-generating element 24 and the pillar 8. Furthermore, in this embodiment, as shown in FIG. 5, the filler 9 is located between the tube 27 and the bar 28 in the internal space 29 of the pillar 8. The filler 9 is electrically insulating and thermally conductive. In this embodiment, the filler 9 is made of a thermosetting resin. A resin that cures at ordinary temperature may be used as the filler 9. A resin having low viscosity is selected as the material of the filler 9 to completely fill the entire gaps within the case 6. Preferred examples of the filler 9 include epoxy resins. In the present specification, the statement that a material is “thermally conductive” means that the thermal conductivity of the material is 0.5 W/m·K or more.

In production of the electronic component 2, the case 6, the tube 27 formed integrally with the case 6, the bar 28, and the toroidal coil 4 are prepared. As shown in FIG. 4, the bar 28 is inserted into the internal space 29 of the tube 27. The heat-generating element 24 is placed into the case 6, with the pillar 8 passing through the hole 15 of the heat-generating element 24, and the top plate 14 is placed on the upper surface of the case 6. Thus, the heat-generating element 24 is contained in the case 6. A liquid thermosetting resin is poured into the case 6 through the hole 34 of the lid 18 of the top plate 14. The thermosetting resin fills the gap between the heat-generating element 24 and the case 6 and the gap between the heat-generating element 24 and the pillar 8. The thermosetting resin further fills the gap between the tube 27 and the bar 28. The thermosetting resin is heated and cured. Thus, the filler 9 is formed. In this manner, the electronic component 2 is obtained.

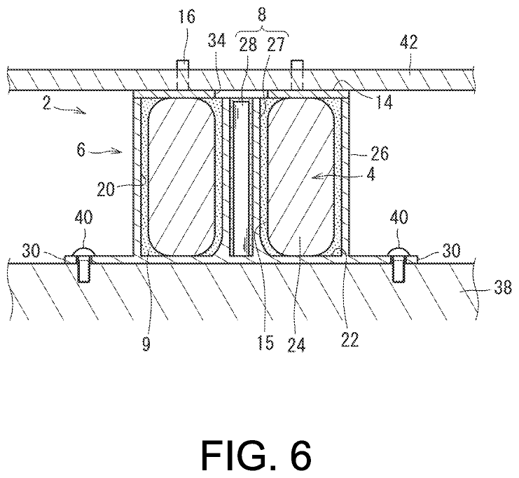

The electronic component 2 obtained is mounted into an electronic device. FIG. 6 is a cross-sectional view showing the electronic component 2 as mounted on a housing 38 of the electronic device. The cross-section of the electronic component 2 which is shown in FIG. 6 is one taken along the line III-III of FIG. 1, just as is the cross-section of FIG. 3. The cross-section of FIG. 6 is taken at a site where there are the protrusions 30 of the case 6. The electronic component 2 is placed such that the bottom surface of the case 6 is in contact with the housing 38. Screws 40 are inserted into screw holes of the housing 38 through the attachment holes 32. The screws 40 fix the electronic component 2 to the housing 38. A circuit board 42 is placed above the electronic component 2. The terminals 16 of the top plate 14 connect with given terminals of the circuit board 42. In this embodiment, the terminals of the circuit board 42 are embodied as through holes, and the terminals 16 of the toroidal coil 4 are inserted into the through holes. Thus, electricity is applied from the circuit board 42 to the toroidal coil 4, bringing the electronic component 2 into operation.

The electronic component 2 may be placed on a heat dissipator of the electronic device. The electronic component 2 may be placed on another component of the electronic device that exhibits a high heat dissipation effect.

The following will describe the advantageous effects of the present embodiment.

The electronic component 2 of the present embodiment includes the pillar 8 extending from the bottom 22 of the case 6 and passing through the annular heat-generating element 24. Since the pillar 8 fills a part of the central hole 15 of the heat-generating element 24, the amount of the filler 9 can be reduced. This contributes to cost reduction. Furthermore, the pillar 8 includes the bar 28 located in its interior and having a higher thermal conductivity than the filler 9. The bar 28 contributes to high heat dissipation performance of the electronic component 2. The electronic component 2 has high heat dissipation performance.

In this embodiment, the tube 27, which is electrically insulating, is located between the bar 28 and the heat-generating element 24. Most metals have a high electrical conductivity and a high thermal conductivity. Even when a metal having a high electrical conductivity is used as the material of the bar 28, short circuit does not occur between the heat-generating element 24 and the bar 28. In the electronic component 2, a metal having a high thermal conductivity can be used as the material of the bar 28. The electronic component 2 has high heat dissipation performance.

In this embodiment, the gap between the tube 27 and the bar 28 is filled with the filler 9. In production of the electronic component 2, when a resin is poured to fill the gap between the case 6 and the heat-generating element 24, the resin can further fill the gap between the tube 27 and the bar 28. Thus, the tube 27 and the bar 28 are fixed together. The production of the electronic component 2 does not require any additional step for fixing the tube 27 and the bar 28 together. The electronic component 2 is easy to produce.

In this embodiment, the bar 28 located in the internal space 29 of the tube 27 is in contact with the bottom 22 of the case 6. As shown in FIG. 6, the electronic component 2 is placed with its bottom surface in contact with the housing 38. Placing the bar 28 in contact with the bottom 22 of the case 6 reduces the distance between the bar 28 and the housing 38. Heat can be effectively dissipated from the bar 28 to the housing 38. The electronic component 2 has high heat dissipation performance.

In this embodiment, the pillar 8 includes the frustum-shaped lower portion 23. The diameter of the lower portion 23 increases with decreasing distance to the bottom surface of the case 6. As shown in FIG. 3, the corner between the inner circumferential surface and lower surface of the annular heat-generating element 24 is usually shaped to have a rounded contour. Despite the fact that the diameter of the lower portion 23 increases with decreasing distance to the bottom surface of the case 6, the lower portion 23 does not obstruct placement of the heat-generating element 24. Since the diameter of the lower portion 23 increases with decreasing distance to the bottom surface of the case 6, the amount of the filler 9 can be reduced. This contributes to cost reduction.

In this embodiment, the pillar 8 extends to the level of the upper end of the case 6 in the up-down direction. Since the pillar 8 extends to the level of the upper end of the case 6, the amount of the filler 9 can be effectively reduced. This contributes to cost reduction.

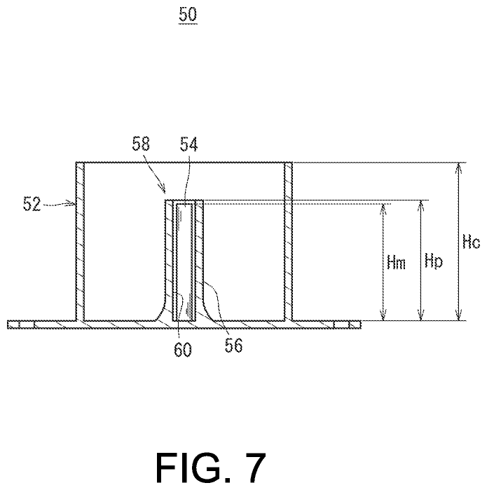

FIG. 7 is a cross-sectional view showing a case 52 and a pillar 54 of an electronic component 50 according to another embodiment. The electronic component 50 further includes a toroidal coil, although the toroidal coil is omitted in FIG. 7. The toroidal coil and the case 52 of the electronic component 50 are respectively the same as the toroidal coil 4 and the case 6 of FIG. 1.

The pillar 54 is located on the bottom of the case 52. The pillar 54 extends upward from the bottom of the case 52. In FIG. 7, the double-headed arrow Hc represents the distance as measured from the bottom of the case 52 to the upper end of the case 52 in the up-down direction. The double-headed arrow Hp represents the distance as measured from the bottom of the case 52 to the upper end of the pillar 54 in the up-down direction. In this embodiment, the pillar 54 does not extend to the level of the upper end of the case 52 in the up-down direction. That is, the distance Hp is smaller than the distance Hc.

The pillar 54 includes a tube 56 and a bar 58. The tube 56 includes an internal space 60. The tube 56 is open at its upper surface. The tube 56 is electrically insulating. In FIG. 7, the double-headed arrow Hm represents the distance as measured from the bottom of the case 52 to the upper end of the bar 58 in the up-down direction. The distance Hm is equal to or smaller than the distance Hp.

In this embodiment, where the pillar 54 does not extend to the level of the upper end of the case 52 in the up-down direction, the height of the bar 58 is relatively small. Thus, the increase in weight of the electronic component 50 is reduced even when a metal having a high thermal conductivity is used as the material of the bar 58.

In terms of cost reduction and high heat dissipation performance, the distance Hp is preferably at least 0.5 times, more preferably at least 0.7 times, the distance Hc. In terms of limiting the weight of the electronic component 50, the distance Hp is preferably at most 0.95 times the distance Hc.

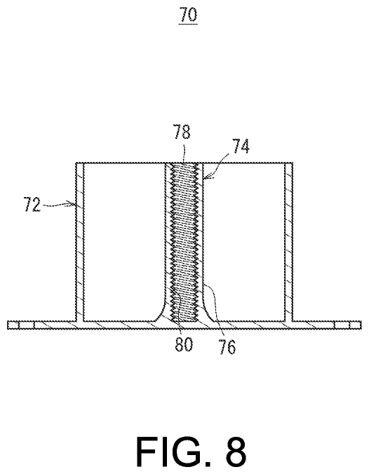

FIG. 8 is a cross-sectional view showing a case 72 and a pillar 74 of an electronic component 70 according to another embodiment. The electronic component 70 further includes a toroidal coil, although the toroidal coil is omitted in FIG. 8. The toroidal coil and the case 72 of the electronic component 70 are respectively the same as the toroidal coil 4 and the case 6 of FIG. 1.

The pillar 74 is located on the bottom of the case 72. The pillar 74 extends upward from the bottom of the case 72. When viewed from outside, the pillar 74 has the same shape as the pillar 8 of FIG. 2.

As shown in FIG. 8, the pillar 74 includes a tube 76 and a bar 78. The tube 76 includes a screw hole 80 extending downward from the upper surface of the tube 76. In this embodiment, the screw hole 80 extends to the bottom of the case 72. The tube 76 is electrically insulating.

The bar 78 takes the form of a screw mating with the screw hole of the tube 76. As shown in FIG. 8, the bar 78 is inserted into the screw hole 80 of the tube 76. Thus, the bar 78 is attached to the tube 76. The bar 78 attached to the tube 76 is in contact with the bottom of the case 72. In this embodiment, there is no gap between the bar 78 and the tube 76.

In the electronic component, the bar 78 takes the form of a screw and the internal space of the tube 76 takes the form of a screw hole. Thus, the bar 78 and the tube 76 can be fixed together easily and firmly.

The bar 78 is not limited to being attached to the tube 76 in the way described above. For example, the bar 78 may be press-fitted into the internal space of the tube 76.

In the embodiments described above, the pillar is circular in a cross-section perpendicular to the up-down direction. The cross-section of the pillar need not be circular. The cross-section of the pillar may be elliptical or polygonal.

In the embodiments described above, the toroidal coil is contained as a heat generator within the case. The heat generator is not limited to toroidal coils. The heat generator may be a reactor, transformer, or resistor. The heat generator may be any other element.

As described above, the electronic components are low in cost and have high heat dissipation performance. This demonstrates the superiority of the described embodiments.

### Disclosed Items

The following items are disclosures of preferred embodiments.

### Item 1

An electronic component including:
an annular heat-generating element;
an electrically insulating case including a bottom and a side wall and containing the heat-generating element;
a pillar extending upward from the bottom and passing through the heat-generating element; and
a thermally conductive filler located within the case, wherein
the pillar includes an electrically insulating tube and a bar located inside the tube and having a higher thermal conductivity than the filler.

### Item 2

The electronic component according to item 1, wherein the filler is located between the tube and the bar.

### Item 3

The electronic component according to item 1 or 2, wherein the pillar extends to a level of an upper end of the case in an up-down direction.

### Item 4

The electronic component according to any one of items 1 to 3, wherein the bar is in contact with the bottom.

### Item 5

The electronic component according to any one of items 1 to 4, wherein the pillar includes: a frustum-shaped lower portion extending from the bottom of the case and having a diameter that gradually decreases upward; and an upper portion extending from the lower portion and having a diameter that is substantially constant up to an upper end of the upper portion.

### Item 6

The electronic component according to any one of items 1 to 5, wherein the heat-generating element includes a coil.

The electronic component as described above is applicable to various electronic devices.

The foregoing description is given for illustrative purposes, and various modifications can be made without departing from the principles of the present invention.

What is claimed is:

1. An electronic component comprising:
an annular heat-generating element;
an electrically insulating case including a bottom and a side wall and containing the heat-generating element;
a pillar extending upward from the bottom and passing through the heat-generating element; and
a thermally conductive filler located within the case, wherein
the pillar includes an electrically insulating tube and a bar located inside the tube and having a higher thermal conductivity than the filler.

2. The electronic component according to claim 1, wherein the filler is located between the tube and the bar.

3. The electronic component according to claim 1, wherein the pillar extends to a level of an upper end of the case in an up-down direction.

4. The electronic component according to claim 1, wherein the bar is in contact with the bottom.

5. The electronic component according to claim 1, wherein the pillar includes: a frustum-shaped lower portion extending from the bottom of the case and having a diameter that gradually decreases upward; and an upper portion extending from the lower portion and having a diameter that is substantially constant up to an upper end of the upper portion.

6. The electronic component according to claim 1, wherein the heat-generating element includes a coil.
